(19) United States
(12) Patent Application Publication
(10) Pub. No.: US 2009/0026001 A1
(43) Pub. Date: Jan. 29, 2009

(54) VEHICLE THROTTLING AND STEERING CONTROL MECHANISM

(76) Inventor: Donald Shaum, Elkhart, IN (US)

Correspondence Address: BARNES & THORNBURG LLP, P.O. BOX 2786, CHICAGO, IL, 60690-2786, US

(21) Appl. No.: 11/782,373

(22) Filed: Jul. 24, 2007

(51) Int. Cl. B60K 26/00; B62D 1/00

(52) U.S. Cl. 180/333; 280/29

(57) ABSTRACT

A mechanism for controlling: (a) the throttling of an engine or other power source of a vehicle, and (b) the steering of the vehicle, the mechanism comprising an element moveable in a linear direction to control the throttling of the power source and rotatable to control the steering of the vehicle. Moving the element in a first linear direction increases the throttling of the power source and moving the element in a second linear direction decreases the throttling of the power source. Rotating the element in one rotational direction steers the vehicle in the right direction and rotating the element in an other rotational direction steers the vehicle in the left direction. The mechanism may further comprise a rod pivotally secured or otherwise secured to an other component of the vehicle. The element may be in the form of a handle rotatably secured to the rod. The vehicle may include a pair of front seats and the element may be positioned forward of the front seats and centered relative to the front seats for easy access for the operator.

The present disclosure relates generally to controlling the throttling of an engine or other power source of a vehicle and the steering of the vehicle.

### BACKGROUND

The operation of an automobile or other motor vehicle requires the use of several different limbs and a variety of motor and sensory skills. To accelerate the vehicle, the operator pushes an accelerator pedal with a foot, and to brake the vehicle the operator pushes the brake pedal with the same foot or perhaps the other foot. In vehicles with manual transmissions, the operator's other foot is used to engage the clutch. To steer the vehicle, the operator typically turns a steering wheel using both arms and both hands. The operator typically also uses both arms and both hands to operate other vehicle functions such as turn signals, headlights, and wipers.

Due to the coordination involved in operating numerous foot and hand pedals and other functions, it is easy for the operator to fail to timely or accurately operate the various functions, resulting in accidents or other dangerous or perhaps inefficient conditions. Moreover, in any event, the use of the one or more pedals and the steering wheel may be inconvenient to operators, even though the use of pedals and a steering wheel is standard in most vehicles. These dangers and inconveniences may be of even more concern for certain operators, especially, for example, elderly or handicapped people who may suffer from reduced physical capabilities.

### SUMMARY

The present disclosure relates to a mechanism for controlling (a) the throttling of an engine or other power source of a vehicle, and (b) the steering of the vehicle. The mechanism comprises an element moveable in a linear direction to control the throttling of the power source and rotatable to control the steering of the vehicle. Moving the element in a first linear direction increases the throttling of the power source and moving the element in a second linear direction decreases the throttling of the power source. Rotating the element in one rotational direction steers the vehicle in one direction and rotating the element in an other rotational direction steers the vehicle in another direction.

The mechanism may further comprise a rod pivotally secured or otherwise secured to an other component of the vehicle. The element may be in the form of a handle rotatably secured to the rod. The vehicle may include a pair of front seats and the element may be positioned forward of the front seats and centered relative to the front seats for easy access for the operator.

Additional features will become apparent to those skilled in the art upon consideration of the following detailed description of drawings exemplifying the best mode as presently perceived.

### BRIEF DESCRIPTION OF THE DRAWINGS

The detailed description particularly refers to the accompanying figures in which:

FIG. 1 is a schematic diagram illustrating directions of movement of a mechanism for controlling the throttling of an engine or other power source of a vehicle and the steering of the vehicle in accordance with an embodiment of the present disclosure;

FIG. 2 is a perspective view of the mechanism of FIG. 1 coupled to a gear valve box of the vehicle and hydrostatic tubes of the vehicle extending from the gear valve box for coupling to a power source and a steering system of the vehicle;

FIG. 3 is a perspective view, schematic in nature, of the mechanism, the valve gear box and the hydrostatic tubes of FIG. 2, a steering column, engine and fuel pump coupled to the gear valve box by the hydrostatic tubes, and a pair of seats of the vehicle; and

FIG. 4 is a perspective view of a vehicle incorporating the mechanism and components of FIGS. 1-3.

### DETAILED DESCRIPTION OF ILLUSTRATIVE EMBODIMENT

While the present disclosure may be susceptible to embodiment in different forms, there is shown in the drawings, and herein will be described in detail, embodiments with the understanding that the present description is to be considered an exemplification of the principles of the disclosure and is not intended to limit the disclosure to the details of construction and the arrangements of components set forth in the following description or illustrated in the drawings.

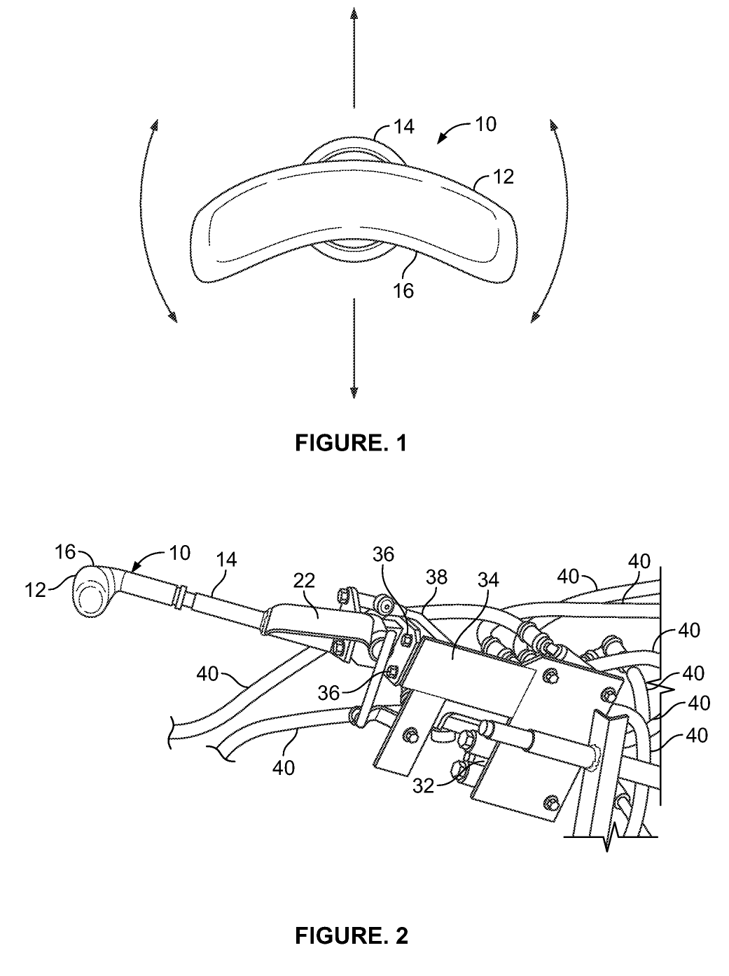

FIG. 1 illustrates a mechanism 10 for controlling the throttling of a power source of a vehicle and the steering of the vehicle. The mechanism 10 comprises an element 12 that is moveable in the linear direction to control the throttling of the power source and rotatable to control the steering. By moving the element 12 in a first linear direction (e.g., a forward linear direction), the throttling is increased and by moving the element in a second linear direction (e.g., a rearward linear direction), the throttling is decreased. The first and second linear directions may be linear to each other, or may be offset relative to each other to, for example, provide a power source neutral position for the element 12. Additionally, by turning the element 12 in one direction (e.g., a right rotation), the vehicle may be steered in one direction, and by turning the element in on other direction, the vehicle may be steered in an other direction. The element 12 may be used in connection with any type of vehicle, and may have any suitable construction and configuration.

The mechanism 10 may also have any suitable construction and configuration. In the embodiment of FIGS. 1-4, for example, the mechanism 10 further comprises a rod 14, and the element 12 is in the form of a handle 16 rotatably secured to the rod. The rod 14 is pivotally secured at one of its ends, and the linear movement of the element 12 described above therefore may include a slight arcuate component caused by the pivoting of the rod 14. The illustrated handle 16 is T-shaped but may instead be round or may have any other suitable construction. The handle 16 may be rotatably secured to the rod 14 in any suitable manner such as, for example, by any suitable bearing components, structure or means. The handle 12 is disposed at an end of the rod 14 opposite the pivotally secured end of the rod. The rod 14 and handle 16 may have any suitable construction and configuration in accordance with other embodiments of the present disclosure.

The illustrated rod 14 and handle 16 are a modification of a control linkage commercially available from John Deere having a blade handle rod for use in a dozer to turn and raise and lower a blade of the dozer. The rod of the commercially-available control linkage is movable in any direction to move the blade in the desired direction and the handle is rotatable to raise and lower the blade. With the illustrated mechanism 10, however, the mounting bracket 22 of the control linkage is welded, soldered or otherwise fixed to the rod 14 to limit the movement of the rod in any direction accept the forward and reverse direction. Movement of the rod 14 can be limited or otherwise restricted in any other manner and with any other structure in accordance with other embodiments of the present disclosure.

The mechanism 10 in accordance with the present disclosure may be coupled to any type of power source that operates on any type of fuel. The power source may be in the form of a type of engine such as, for example, any engine included with any commercially-available automobile or truck or any other engine included with any other commercial or industrial vehicle. The mechanism 10 may be coupled to a gas pedal line of the engine or may otherwise be operatively coupled to the engine by any suitable means, including any suitable means by which accelerator pedals are operatively coupled to power sources in commercial automobiles or trucks or other commercially-available or industrial vehicles. The mechanism 10 may include an engine neutral position, and any suitable structure, system or means can be included to allow the vehicle to shift between the forward and reverse directions.

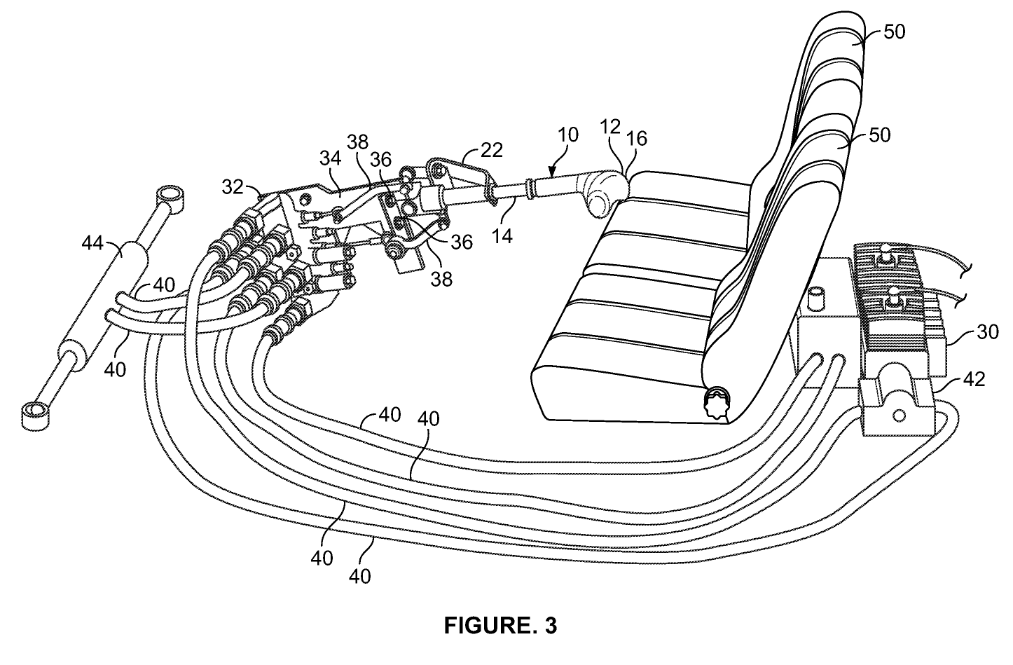

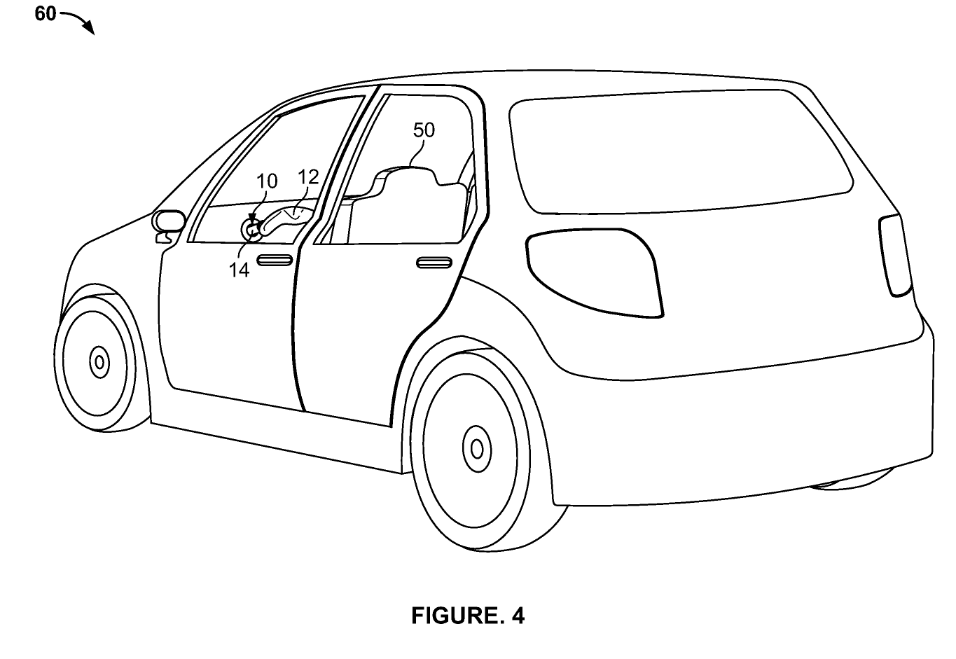

FIG. 3 shows an alternative manner in which the mechanism 10 may be operatively coupled to an engine 30 through hydrostatic pressure means. The embodiment illustrated in FIG. 3 shows the mechanism 10 secured to a gear valve box 32 by a support bracket 34, a plurality fasteners 36 and a pair of mounting arms 38. The gear valve box 32 is hydrostatically connected to the engine by a plurality of hoses 40 which couple the mechanism 1 to the engine 30, a fuel pump 42 and a steering cylinder 44. The gear valve box 32 may be in any form including any type of hydraulic control valve commercially available from John Deere or from any other source or constructed in any other manner.

The mechanism 10 may be coupled to any suitable steering system, including any suitable steering systems available in commercially-available automobiles or trucks or any other commercially-available or industrial vehicles. The mechanism 10 may be engaged with a steering column or otherwise operatively coupled to the steering system by any suitable means, including any suitable means by which steering components are operatively coupled within a steering system in commercially-available automobiles or trucks or any other commercially-available or industrial vehicles.

FIG. 3 shows an alternative manner in which the mechanism 10 may be operatively coupled to a steering system by hydrostatic means. FIG. 3 shows the steering cylinder and some of the hoses 40 hydrostatically coupling the gear valve box 34 to the steering cylinder 44.

The mechanism 10 can also be included in any type of vehicle 12, including, for example, any commercially-available automobile or truck or any other type of commercially-available or industrial vehicle, including but not limited to any type of trucks, buses, RV's, golf carts, farm equipment, construction equipment, excavation equipment, off-road vehicles, shipping vehicles, cargo vehicles, aircrafts, etc. In accordance with other embodiments, the vehicle 12 can instead by in the form of a simulated vehicle such as a vehicle simulated in a video game, computer game or other video, computer or electronic apparatus. In accordance with such embodiments, the power source and the steering system may instead by in the form of a simulated power source or steering system.

The mechanism 10 can be positioned between a pair of front seats 50 of an automobile 60 or other type of vehicle in accordance with the embodiments of FIGS. 3 and 4. The rod 14 of the mechanism 10 may be pivotally secured to or adjacent the floor or any other component of the automobile 60. The rod 14 extends forward of the pair of front seats 50 and centered relative to the pair of front seats. The automobile 60 includes a cabin 62, and the front seats 50 and the mechanism 10 are disposed within the cabin in such an arrangement. Such positioning of the mechanism 10 may provide convenience to the operator and also provides the ability for the mechanism to be operated from either of the seats 50. The mechanism 10 may be pivotally secured or otherwise secured at any other location of the automobile 60 or other type of vehicle, and the rod 14 may extend and the handle 16 may be disposed at any other location within the cabin 62 of the automobile 60 in accordance with other embodiments of the present disclosure. Further, the automobile or other vehicle may instead have a single seat, any other number of seats or no seats in accordance with other embodiments of the present disclosure.

While a preferred embodiment of the disclosure is shown and described, it is envisioned that those skilled in the art may devise various modifications and equivalents without departing from the spirit and scope of the disclosure. The present disclosure relates to one or more of the following features, elements, steps, or combinations thereof:

What is claimed:

1. A mechanism for controlling: (a) the throttling of a power source of a vehicle, and (b) the steering of the vehicle, the mechanism comprising an element moveable in a linear direction to control the throttling of the power source of the vehicle and rotatable to control the steering of the vehicle.

2. The mechanism of claim 1 further comprising a rod coupled to the element, the rod moveable with the element in the linear direction to control the throttling of the power source of the vehicle and the element rotatable relative to the rod to control the steering of the vehicle.

3. The mechanism of claim 2 wherein the element is disposed at an end of the rod.

4. The mechanism of claim 2 wherein the element comprises a handle rotatably secured to the rod.

5. The mechanism of claim 2 wherein the rod is pivotably secured to a component of the vehicle.

6. The mechanism of claim 2 wherein the rod has a pair of ends, the rod being pivotally secured to a component of the vehicle at one end and the element being disposed at the other end.

7. The mechanism of claim 1 wherein moving the element in a forward linear direction increases the throttling of the power source and moving the element in a rearward linear direction decreases the throttling of the power source.

8. The mechanism of claim 7 wherein the element is moveable to a neutral position.

9. The mechanism of claim 1 wherein the element is rotatable in a first direction to steer the vehicle towards the right and the element is rotatable in a second direction to steer the vehicle towards the left.

10. The mechanism of claim 1 wherein the element is in hydraulic engagement with the power source of the vehicle.

11. The mechanism of claim 1 further comprising means for reversing the direction of the vehicle in response to the throttling of the power source.

12. The mechanism of claim 1 wherein the element is disposed forward of a pair of front seats of the vehicle and centered relative to the pair of front seats.

13. A vehicle comprising an engine and a mechanism comprising an element moveable in a linear direction to control the throttling of the engine and rotatable to control the steering of the vehicle.

14. The vehicle of claim 13 wherein the vehicle further comprises a cabin and the mechanism further comprises a rod extending within the cabin, the element rotatably secured to the rod, the element rotatable relative to the rod.

15. The vehicle of claim 14 wherein the cabin has a front center area and the element is positioned within the front center area.

16. The vehicle of claim 14 further comprising a pair of front seats within the cabin, the rod centered relative to the pair of front seats.

17. The vehicle of claim 13 wherein moving the element in the forward direction increases the throttling of the engine and moving the element in the rearward direction decreases the throttling of the engine.

18. The vehicle of claim 17 wherein the element is moveable to a neutral position to put the engine in a neutral gear.

19. The vehicle of claim 13 wherein the mechanism further comprises a rod coupled to the element, the rod moveable with the element to control the throttling of the engine and the element rotatable relative to the rod to control the steering of the vehicle.

20. The vehicle of claim 19 wherein the element is rotatable in a first direction to steer the vehicle towards the right and the element is rotatable in a second direction to steer the vehicle towards the left.

21. The vehicle of claim 13 wherein the rod has a pair of ends, the rod being pivotally secured to an other component of the vehicle at one end and the element being disposed at the other end.

22. A vehicle comprising an engine and a mechanism comprising a pivotally secured rod having an end and a handle rotatably secured to the end of the rod, the handle moveable in a linear direction to control the throttling of the engine and rotatable relative to the rod to control the steering.

23. The vehicle of claim 22 wherein moving the handle in the forward direction increases the throttling of the engine and moving the handle in the rearward direction decreases the throttling of the engine.

24. The vehicle of claim 23 wherein the handle is moveable to a neutral position to put the engine in a neutral gear.

25. The vehicle of claim 22 wherein the handle is rotatable in a first direction to steer the vehicle towards the right and the handle is rotatable in a second direction to steer the vehicle towards the left.

26. The vehicle of claim 22 wherein the vehicle further comprises a cabin and a pair of front seats disposed within the cabin, the rod extending within the cabin, the rod positioned forward of and centered relative to the pair of front seats.
